(19) United States
(12) Patent Application Publication
(10) Pub. No.: US 2012/0092574 A1
(43) Pub. Date: Apr. 19, 2012

(54) LIQUID CRYSTAL DISPLAY DEVICE

(75) Inventor: Shigeki Tanaka, Osaka (JP)

(73) Assignee: SHARP KABUSHIKI KAISHA, Osaka (JP)

(21) Appl. No.: 13/376,492

(22) PCT Filed: Mar. 31, 2010
(86) PCT No.: PCT/JP10/55867

§ 371 Date: Dec. 6, 2011

(30) Foreign Application Priority Data
Jun. 11, 2009 (JP) 2009-139812

(51) Int. Cl. G02F 1/135

(52) U.S. Cl. 349/24

(57) ABSTRACT

Provided is a liquid crystal display device with a high degree of freedom in the size of pixel electrodes. A liquid crystal display device (1) of the present invention includes a first substrate (11) having a plurality of pixel electrodes (2) affixed thereto, a second substrate (12) which is provided with an opposite electrode (3) that faces the pixel electrodes (2) and which faces the first substrate (11), and a liquid crystal layer (4) that is interposed between the first substrate (11) and the second substrate (12) and that contains vertical orientation type crystal molecules (14). The liquid crystal molecules (14) are aligned and tilted radially or concentrically with respect to each of the pixel electrodes (2) in response to the voltage applied between the pixel electrodes (2) and the opposite electrode (3). Either one or both of the aforementioned substrates (11)(12) have a photo-aligning vertical alignment film (5) which exhibits an orientation control force in response to light illumination, and the aforementioned photo-aligning vertical alignment film (5) contains a plurality of orientation control surfaces (15) which control the orientation of the liquid crystal molecules (14) radially, corresponding to the respective pixel electrodes (2).

### TECHNICAL FIELD

The present invention relates to a liquid crystal display device, and more particularly, to a liquid crystal display device having a wide viewing angle characteristic and performing a high quality display.

### BACKGROUND ART

Conventionally, liquid crystal display devices using a liquid crystal layer with a CPA (Continuous Pinwheel Alignment) mode are well known (see Patent Document 1, for example). This type of liquid crystal display devices uses a vertical orientation type liquid crystal layer in a manner similar to a VA (Vertical Alignment) mode and its response speed is faster than a TN (Twisted Nematic) mode and the like.

In addition, a CPA mode liquid crystal display device has a plurality of pixel electrodes with rounded edges and generates a particular electric field (a so-called oblique electric field) based on a shape of the aforementioned pixel electrodes when voltage is applied. The aforementioned liquid crystal display device can align and tilt liquid crystal molecules radially with respect to each pixel using its particular electric field. Therefore, the CPA mode liquid crystal display device can tilt liquid crystal molecules in all directions continuously and has an excellent wide viewing angle characteristic.

This type of liquid crystal display devices with an excellent wide viewing angle characteristic is widely used for monitors of personal computers, display devices of personal digital assistant devices, television receivers and the like.

The CPA mode liquid crystal display device, described in the aforementioned Patent Document 1, has protrusion portions to facilitate the tilt-orientation of liquid crystal molecules by an oblique electric field when voltage is applied. As shown in Patent Document 1, these protrusion portions (the punctate protrusion and linear protrusion in Patent Document 1) is provided on the opposite electrode facing the pixel electrodes through a liquid crystal layer. Each of the aforementioned protrusion portions is provided so as to correspond to the approximate center of respective pixel electrodes. The presence of this type of protrusion portions facilitates the radial tilt-orientation of the liquid crystal molecules such that the liquid crystal molecules surround the protrusion portions when voltage is applied.

### RELATED ART DOCUMENTS

### Patent Documents

Patent Document 1: Japanese Patent Application Laid-Open Publication No. 2008-304544

### SUMMARY OF THE INVENTION

### Problems to be Solved by the Invention

The CPA mode liquid crystal display device, described in the aforementioned Patent Document 1 and the like, is normally set to display black when no voltage is applied. This setting is so called a normally black type. When voltage is not applied (when no voltage is applied), it is preferable that liquid crystal molecules be all vertically aligned in a liquid crystal layer of a liquid crystal display device.

However, when the aforementioned protrusion portions are provided on the opposite electrodes as in the aforementioned Patent Document 1 and the like, the protrusion portions act on the liquid crystal molecules present in its surroundings and tilt the liquid crystal molecules when no voltage is applied. This is because there is an alignment film to vertically align liquid crystal molecules between the opposite electrode in which the aforementioned protrusion portions are provided and the liquid crystal layer when no voltage is applied, and this alignment film is deformed in a manner of projecting into the liquid crystal layer by the aforementioned protrusion portions. When deformed, the alignment film acts on the liquid crystal molecules on the film surface in its deformed state. Therefore, the liquid crystal molecules tilt as described above.

When liquid crystal molecules tilt in the black display, the tilted liquid crystal molecules become a cause of a light leakage, and furthermore a cause of a lower contrast. The problems such as a lower contrast and the like become more pronounced when the protrusion portions are set large. Therefore, from the viewpoint of suppressing a light leakage and a low contrast, it is desirable that the size of the aforementioned protrusion portions be set small.

However, if the aforementioned protrusion portions are too small relative to the size of the pixel electrodes, the response speed of a liquid crystal display device becomes slower. When voltage is applied to a CPA mode liquid crystal display device, the force to orient liquid crystal molecules radially (so called an orientation control force) appears most significantly in the proximity of the protrusion portions which are placed approximately at the center of pixel electrodes and in the proximity of the edge area (the periphery) of pixel electrodes. As a result, the orientation of the liquid crystal molecules starts to change from the liquid crystal molecules placed adjacent to these areas and the liquid crystal molecules begin to tilt. Then the liquid crystal molecules that exist therebetween also start to change the orientation progressively and sequentially tilt. Therefore, if the pixel electrodes are large relative to the aforementioned protrusion portions, the distance between the aforementioned protrusion portions and the edge area becomes longer and it takes a long time for all the liquid crystal molecules to complete tilting.

As described above, the CPA mode liquid crystal display device that controls the orientation of liquid crystal molecules using the protrusion portions shown in the aforementioned Patent Document 1 and the like actually had limitations such as an inability to set the pixel electrodes large due to a lower contrast and slower response speed.

The purpose of the present invention is to provide a liquid crystal display device with a high degree of freedom in the size of pixel electrodes.

### Means for Solving the Problems

A liquid crystal display device according to the present invention includes a first substrate having a plurality of pixel electrodes thereon, a second substrate provided with an opposite electrode that faces the pixel electrodes, the second substrate facing the first substrate, and a liquid crystal layer that is interposed between the first substrate and the second substrate and that contains vertical orientation type liquid crystal molecules, wherein the liquid crystal molecules are aligned and tilted radially or concentrically with respect to the aforementioned pixel electrodes in response to voltage applied between the pixel electrode and the opposite electrode, wherein either one or both of the substrates have a photo-aligning vertical alignment film which exhibits an orientation control force in response to light illumination, and wherein the photo-aligning vertical alignment film is disposed to correspond to each of the pixel electrodes and contains a plurality of orientation control surfaces that control the orientation of the liquid crystal molecules radially.

In the aforementioned liquid crystal display device, it is preferable that the respective orientation control surfaces of the photo-aligning vertical alignment film exhibits the orientation control force in response to radial or concentric light illumination.

In the aforementioned liquid crystal display device, each of the orientation control surfaces of the photo-aligning vertical alignment film is formed by a pinhole exposure, for example.

In the aforementioned liquid crystal display device, each of the orientation control surfaces of a photo-aligning vertical alignment film is formed by a microlens exposure, for example.

In the aforementioned liquid crystal display device, the pixel electrodes have a rounded shape, for example.

In the aforementioned liquid crystal display device, the pixel electrode includes a plurality of sub-pixel electrodes, for example.

In the aforementioned liquid crystal display device, it is preferable that the liquid crystal layer including the vertical alignment type liquid crystal molecules contains a chiral agent.

### EFFECTS OF THE INVENTION

The liquid crystal display device in the present invention offers a high degree of freedom in the size of pixel electrodes.

### BRIEF DESCRIPTION OF THE DRAWINGS

FIG. 1 is an explanatory drawing (cross-sectional view) schematically illustrating a portion of a liquid crystal display device according to an embodiment of the present invention.

FIG. 2 is an explanatory drawing (plan view) schematically illustrating a structure of one of pixel areas in the liquid crystal display device shown in FIG. 1.

FIG. 3 is an explanatory drawing (plan view) schematically illustrating a portion of a photo-aligning vertical alignment film of a CF substrate.

FIG. 4 is an explanatory drawing schematically illustrating a method to form orientation control surfaces on a photo-aligning vertical alignment film using pinholes.

FIG. 5 is an explanatory drawing schematically illustrating a method of forming orientation control surfaces on a photo-aligning vertical alignment film using microlenses.

FIG. 6 is an explanatory drawing (plan view) schematically illustrating a portion of a photo-aligning vertical alignment film of the CF substrate according to another embodiment.

### DETAILED DESCRIPTION OF EMBODIMENTS

Embodiments of a liquid crystal display device according to the present invention are described with references to the figures below. However, the present invention is not limited to the examples shown in the present specification.

In the present specification, the term “pixel” refers to a smallest unit that represents a specified gradation in the display. In the color display, a pixel corresponds to a unit representing any one of the gradations of R (red), G (green) and B (blue), for example, and is also called a dot. The combination of R pixels, G pixels and B pixels constitutes a color display. In addition, the term “a pixel area” refers to an area of a liquid crystal display device corresponding to “a pixel” in the display.

### Liquid Crystal Display Device

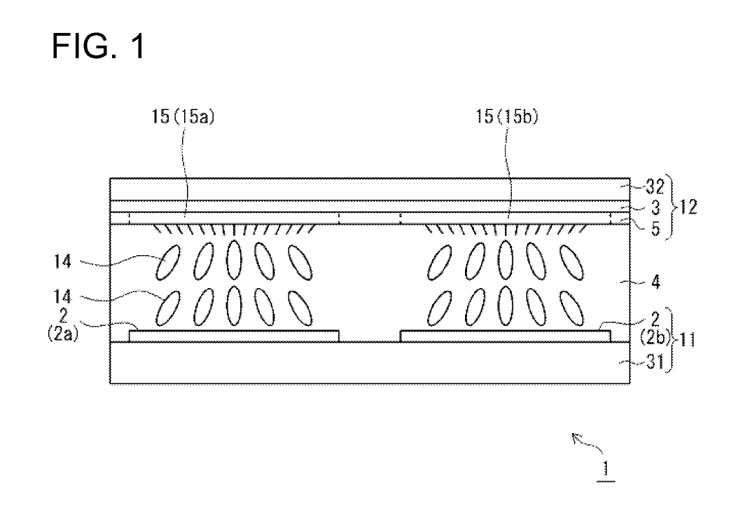

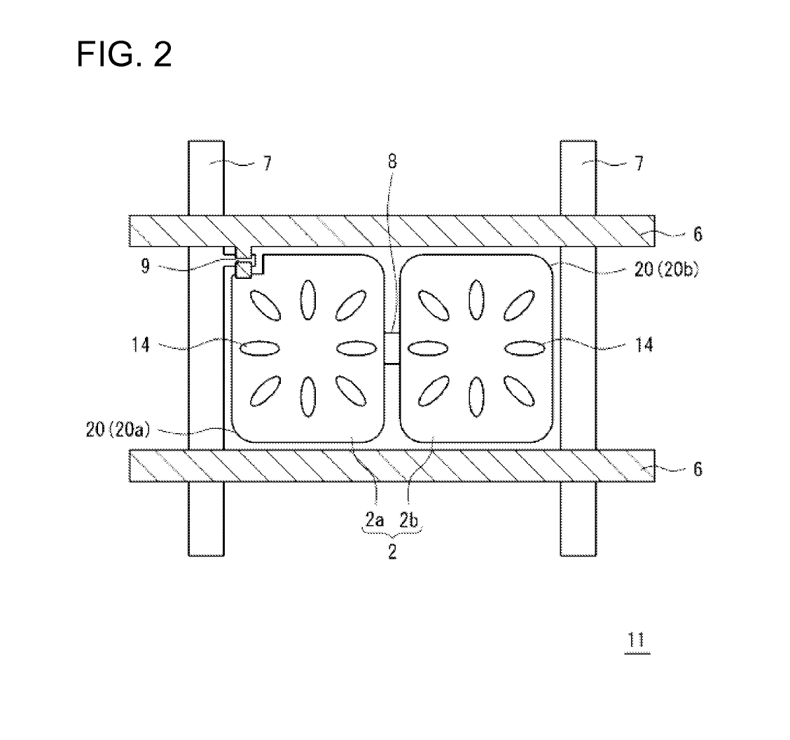

A liquid crystal display device 1 of the present embodiment is described with reference to FIGS. 1 and 2. FIG. 1 is an explanatory drawing (cross-sectional view) schematically illustrating a portion of the liquid crystal display device 1 according to the embodiment. FIG. 2 is an explanatory drawing (plan view) schematically illustrating the structure of single pixel area in the liquid crystal display device 1 of FIG. 1.

As shown in FIG. 1, the liquid crystal display device 1 is so called a transmissive liquid crystal display device and is provided with a thin film transistor (TFT) substrate 11, which is a first substrate, a color filter (CF) substrate 12, which is a second substrate, and a liquid crystal layer 4 interposed between these substrates 11 and 12. The TFT substrate l land the CF substrate 12 face each other in a manner of sandwiching the aforementioned liquid crystal layer 4. Furthermore, these substrates 11 and 12 are provided with a pair of polarizing plates arranged in crossed Nicols (not shown) and are set in a normally black type.

The aforementioned liquid crystal layer 4 is a vertical alignment type liquid crystal layer, and is a liquid crystal layer in which liquid crystal molecule axes are aligned at an angle of equal or greater than approximately 85° with respect to the surface of the vertical alignment film. The liquid crystal molecules 14 in the liquid crystal layer 4 have a negative dielectric anisotropy. The liquid crystal layer 4 together with the liquid crystal molecules 14 contains a chiral agent (not shown). The inclusion of a chiral agent raises the efficiency of light utilization. As the chiral agent, a material commonly used in a CPA mode and the like can be used, for example.

The aforementioned TFT substrate 11 contains a transparent glass plate 31, TFTs 9 (see FIG. 2) as a plurality of switching elements formed in a matrix on the glass plate 31, and pixel electrodes 2 (2a, 2b).

FIG. 2 is a plan view of the aforementioned TFT substrate 11. As shown in FIG. 2, a pixel electrode 2 is divided into two sub-pixel electrodes 2a and 2b, and these sub-pixel electrodes 2a and 2b are electrically connected by a connection portion 8. The aforementioned pixel electrodes 2 (2a, 2b) are made of a transparent thin film conductor such as ITO, and have a rounded shape. In the present embodiment, the respective sub pixel electrodes 2a and 2b are shaped like a square with its four corners cut off. Rounding the edges (the edge portions) 20 of the pixel electrodes 2, that is, rounding the edges (the edge portions) 20a and 20b of the respective sub pixel electrodes 2a and 2b, facilitate the radial tilt-orientation of the liquid crystal molecules 14 toward the center of the respective sub pixel electrodes 2a and 2b when voltage is applied.

In addition, as illustrated in FIG. 2, signal lines (source lines) 6 and scan lines (gate bus lines) 7 are formed in a manner of surrounding the aforementioned pixel electrodes 2. The signal lines 6 and the scan lines 7 are arranged so as to be perpendicular to one another. Furthermore, in the intersections of the signal lines 6 and the scan lines 7, the aforementioned TFTs 9 are provided. The source electrode (not shown) of the TFT 9 is connected to the signal line 6 and the gate electrode (not shown) is connected to the scan lines 7, respectively. In addition, the drain electrode (not shown) of the TFT 9 is electrically connected to the pixel electrode 2 (the sub pixel electrode 2a).

The aforementioned CF substrate 12 includes a transparent glass plate 32, an opposite electrode (common electrode) 3, which is provided on the glass plate 32, and a photo-aligning vertical alignment film 5, which is provided to cover the opposite electrode 3. In addition, a CF layer (not shown) corresponding to one of the three primary RGB colors is placed between the aforementioned glass plate 32 and the opposite electrode 3.

The aforementioned opposite electrode 3 is made of a transparent thin film conductor such as ITO and is formed continuously to cover the glass plate 32 and face the pixel electrode 2 (2a and 2b) of the aforementioned TFT substrate 11 through the liquid crystal layer 4.

The aforementioned photo-aligning vertical alignment film 5 is made of a material with an orientation control force (a vertical orientation) which vertically aligns the liquid crystal molecules 14 of the liquid crystal layer 4, in a manner similar to an alignment film conventionally used in this type of liquid crystal display devices.

Here, however, the aforementioned photo-aligning vertical alignment film 5 additionally has a photosensitivity and is made of a material (having a photo aligning property) that exhibits an orientation control force, which aligns and tilts the liquid crystal molecules 14 in response to light illumination (exposure) of ultraviolet light or the like. The tilt angles of the liquid crystal molecules 14 are controlled by this orientation control force (a tilt orienting property). This type of material includes publicly known photo-aligning alignment film materials, such as polyimide side-chain substituted by azobenzene, polyimide side-chain substituted by cinnamate, coumarin, and the like, for example.

As shown in FIG. 1, the aforementioned alignment film 5 contains a plurality of orientation control surfaces 15 (15a, 15b). These orientation control surfaces 15 (15a, 15b) are placed so as to face the respective pixel electrodes 2 (2a and 2b) of the TFT substrate 11.

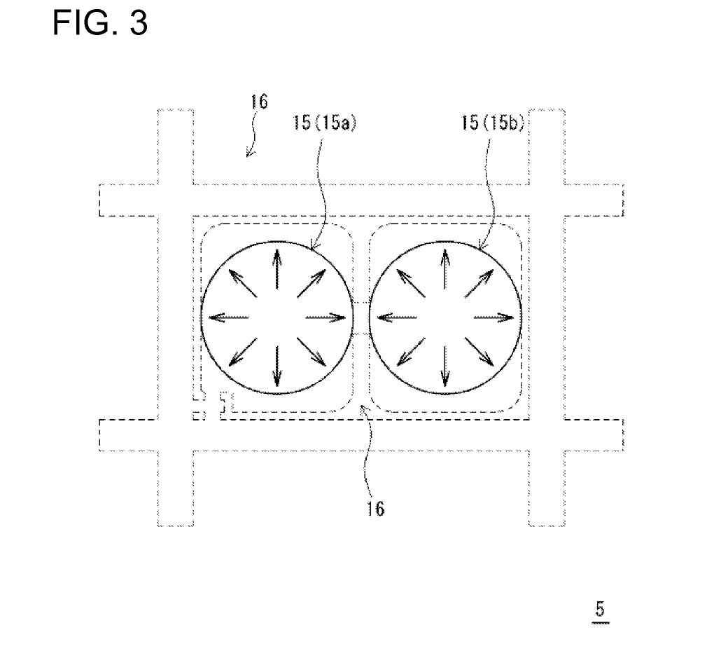

The aforementioned alignment film 5 is described further with reference to FIG. 3. FIG. 3 is an explanatory drawing (plan view) schematically illustrating a portion of the photo-aligning vertical alignment film 5 of the CF substrate 12. In the present embodiment, the size (area) of the respective orientation control surfaces 15 (15a, 15b) is set so as to have approximately the same size as the respective sub pixel electrodes 2a and 2b. However, the size of the orientation control surfaces 15 does not necessarily have to match the size of the pixel electrodes 2 (the sub pixel electrodes 2a and 2b).

The orientation control force of the orientation control surfaces 15 (15a, 15b) acts on the liquid crystal molecules 14 of the liquid crystal layer 4 even when no voltage is applied.

In addition, the dotted lines shown in FIG. 3 illustrate the locations of the pixel electrodes 2 (2a, 2b) and the like on the TFT substrate 11 which face the orientation control surfaces 15 (15a, 15b). Furthermore, the arrow lines in the orientation control surfaces 15 (15a, 15b) shown in FIG. 3 are a schematic illustration of the light illumination directions of ultraviolet light or the like. In addition, for convenience of explanation, the light illumination directions in FIG. 3 are illustrated so as to follow the in-plane directions of the aforementioned alignment film 5.

The area of the orientation control surfaces 15 (15a, 15b) in FIG. 3 corresponds to the area exposed by ultraviolet light or the like. As illustrated in FIG. 3, the orientation control surfaces 15a and 15b are placed so as to correspond to the respective sub pixel electrodes 2a and 2b. In addition, an area 16 of the aforementioned alignment film 5, which excludes the area of the orientation control surfaces 15, has a vertical orientation in a manner similar to a conventional alignment film.

With reference to FIG. 1, an orientation state of liquid crystal molecules in the liquid crystal display device 1 when voltage is applied (color display) and when no voltage is applied (black display) is described.

In the liquid crystal display device 1 shown in FIG. 1, when voltage is applied between each of the pixel electrodes 2 (2a, 2b) and the opposite electrode 3, an oblique electric field is generated in each of the pixel electrodes 2 (2a, 2b), and the liquid crystal molecules 14 in the liquid crystal layer 4 are aligned and tilted radially about the approximate center of the respective orientation control surfaces 15a and 15b of the alignment film 5 formed on the CF substrate 12. However, the liquid crystal molecules 14 in the proximity of the surface of the respective orientation control surfaces 15a and 15b are slightly tilted (approximately 1°) by the action of the respective orientation control surfaces 15a and 15b, so as to center the approximate centers of the respective orientation control surfaces 15a and 15b even when no voltage is applied. These slightly-tilted liquid crystal molecules 14 trigger the radial alignment and tilting of the entire liquid crystal molecules 14 when voltage is applied.

On the other hand, when no voltage is applied in the liquid crystal display device 1 of FIG. 1, the liquid crystal molecules 14 as a whole are aligned vertically with respect to the aforementioned alignment film 5 by the action of the alignment film 5. In addition, the liquid layer display device 1 of the present embodiment is provided with an alignment film (not shown), which vertically aligns liquid crystal molecules, on the side of the TFT substrate 11 as well.

In addition, as described above, the liquid crystal molecules 14 in the proximity of the surface of the respective orientation control surfaces 15 (15a, 15b) of the aforementioned alignment film 5 are tilted by the action of the respective orientation control surfaces 15 (15a, 15b) even when no voltage is applied. However, the tilt is very small (approximately 1°), and therefore the tilted liquid crystal molecules do not cause light leakage or lower contrast.

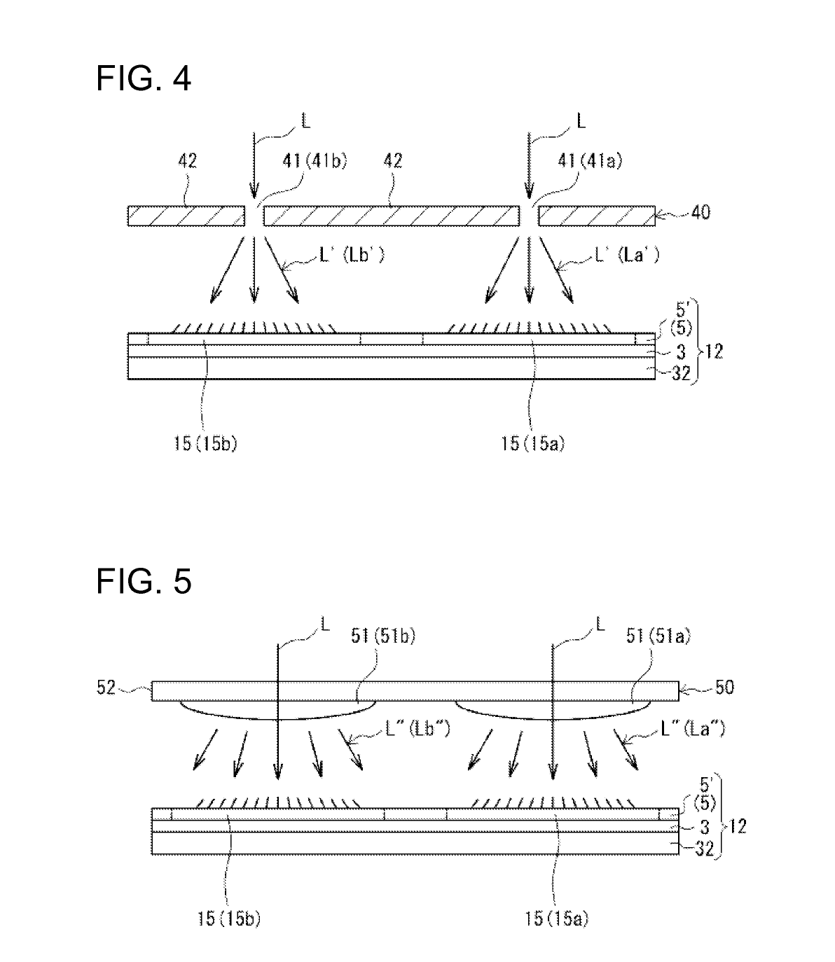

With reference to FIGS. 4 and 5, methods for forming the orientation control surfaces 15 on the aforementioned alignment film 5 is described below.

FIG. 4 is an explanatory drawing schematically illustrating a method for forming the orientation control surfaces 15 on the aforementioned alignment film 5 using pinholes 41. FIG. 5 is an explanatory drawing schematically illustrating a method for forming the orientation control surfaces 15 on the aforementioned alignment film 5 using microlenses 51.

FIG. 4 illustrates the CF substrate 12 in which the material 5′ of the photo-aligning vertical alignment film 5 in a non-exposure state is formed and an exposure equipment 40, which is placed on the upper side of the CF substrate 12. The aforementioned material 5′ of the photo-aligning vertical alignment film 5 can be formed by a conventional coating method used for a conventional alignment film material, for example. The aforementioned exposure equipment 40 is made of a masking portion 42 in a plate form, which is made of a light-shielding material, and a plurality of pinholes 41 (41a, 41b) which are made of holes penetrating the masking portion 42. The respective pinhole areas 41 are placed in a matrix in the exposure equipment 40 in order to form the respective orientation control surfaces 15 (15a, 15b) corresponding to the respective pixel electrodes 2 (2a, 2b) (see FIGS. 1 and 2) of the TFT substrate 11.

The aforementioned exposure equipment 40 is in a plate form as a whole and is placed so as to be substantially in parallel with the aforementioned CF substrate 12. By having a light L such as ultraviolet light irradiate from the light source (not shown) placed on the upper side of this exposure equipment 40 and pass through the aforementioned pinholes 41 (41a, 41b), diffraction rays L′ are generated. Diffraction rays L′ (La′, Lb′) generated in the pinholes 41 (41a, 41b) progress radially from the respective pinholes 41 (41a, 41b) and the light is radiated radially or concentrically on the surface of the material 5′ of the aforementioned photo-aligning vertical alignment film 5. As a result, the aforementioned material 5′ photo-reacts to these diffraction rays L′ (La′, Lb′) and an orientation control force is imparted by the photoreaction. This orientation control force acts to align and tilt liquid crystal molecules.

According to the method using the pinholes shown in FIG. 4, the orientation control surfaces 15 (15a, 15b) can be formed on the aforementioned material 5′ and the photo-aligning vertical alignment film 5 in the present embodiment can be obtained. As described, the exposure method that uses pinholes (the pinhole areas 41) is specifically referred to as a “pinhole exposure” in the present specification.

In addition, if various conditions, such as the diameter of the pinhole areas 41, the shape of the pinholes 41, a distance between the light source and the exposure equipment 40, the distance between the exposure equipment 40 and the aforementioned material 5′, the light source condition (the illumination angle, illumination strength, illumination area, for example), or a combined use with other optical members and the like, are properly set, the shape, size (area), and the like of the orientation control surfaces 15 (15a, 15b) can be adjusted appropriately.

Next, the method shown in FIG. 5 is described. In the same manner as FIG. 4, FIG. 5 illustrates the CF substrate 12 in which the material 5′ of the photo-aligning vertical alignment film 5 in a non-exposure state is formed. As shown in FIG. 5, another exposure equipment 50 using microlenses 51 is placed on the upper side of this CF substrate 12.

The aforementioned exposure equipment 50 includes a light-transmissive supporting plate 52, and a plurality of microlenses 51(51a, 51b) provided on the surface of the CF substrate 12 side of this supporting plate 52. The respective microlenses 51 (51a, 51b) are placed in a matrix by the exposure equipment 50 so as to form the respective orientation control surfaces 15 (15a, 15b) corresponding to the respective pixel electrodes 2 (2a, 2b) (see FIGS. 1 and 2) of the TFT substrate 11.

The aforementioned exposure equipment 50 is in a plate form as a whole and is placed so as to be substantially in parallel with the aforementioned CF substrate 12. By having the light L such as ultraviolet light irradiate from the light source (not shown) placed on the upper side of this exposure equipment 50 and by having the light L pass through the aforementioned microlenses 51 (51a, 51b), the light L″ (La″, Lb″) which progress radially is generated. The light L″ (La″, Lb″) that have passed through the aforementioned microlenses 51 (51a, 51b) progress radially from the respective microlenses 51 (51a, 51b), and the light is radiated radially (or concentrically) on the surface of the aforementioned material 5′ of the aforementioned photo-aligning vertical alignment film 5.

Then, the aforementioned material 5′ photo-reacts to the light L″ (La″, Lb″) and an orientation control force is imparted by the photoreaction. This orientation control force acts to align and tilt liquid crystal molecules. In this way, the orientation control surfaces 15 (15a, 15b) can be formed on the aforementioned material 5′ and the photo-aligning vertical alignment film 5 can be obtained in the present embodiment. As described, the exposure method which uses the microlenses 51 is specifically referred to as a “microlens exposure” in the present specification.

In addition, if various conditions, such as the diameter and the shape (curvature) of the microlenses 51, the distance between the light source and the exposure equipment 50, the distance between the exposure equipment 50 and the aforementioned material 5′, the light source condition (the illumination angle, illumination strength, illumination area, for example), or a combined use with other optical members and the like, are properly set, the shape, size (area), and the like of the orientation control surfaces 15 (15a, 15b) can be adjusted accordingly.

In the these embodiments, the alignment film 5 of the liquid crystal display device 1 uses the area in which the light such as ultraviolet light is radiated (exposure) as the orientation control surfaces 15. However, in other embodiments, it is possible to use an area in which the light is not radiated (exposure) as an orientation control surface if an orientation control surface has a control force by aligning and tilting liquid crystal molecules.

As described above, the liquid crystal display device 1 of the present embodiment controls the orientation of liquid crystal molecules radially, using only the alignment film 5. Therefore, it is not necessary to use protrusions (ribs) as in the case of the conventional liquid crystal display devices.

Thus, in the liquid crystal display device 1 of the embodiments of the present invention, even when the size of the pixel electrodes 2 is changed as needed, neither lower contrast nor slower response speed are caused by the change. Therefore, it can be said that the liquid crystal display device 1 of the embodiments of the present invention has a high degree of freedom in the size of pixel electrodes.

Furthermore, in the liquid crystal display device 1 of the above embodiments, an alignment film (not shown) provided on the side of the TFT substrate 11 may be similar to a conventional vertical alignment film, or may be made of the same material as the photo-aligning vertical alignment film 5 of the aforementioned CF substrate 12.

The liquid crystal display device 1 of the above embodiments was a transmissive type, but in other embodiments, it may be of other types such as a reflective type, a projection type, a transmissive/reflective dual type, and the like.

The liquid crystal display device 1 of the above embodiments was in a mode using linear polarized light as the polarized light, but in other embodiments, circularly polarized light or elliptically polarized light may be used.

In addition, in other embodiments, a photo-aligning vertical alignment film containing an orientation control surface may be provided on the TFT substrate 11, and a photo-aligning alignment film containing an orientation control surface also may be provided on both the TFT substrate 11 and the CF substrate 12.

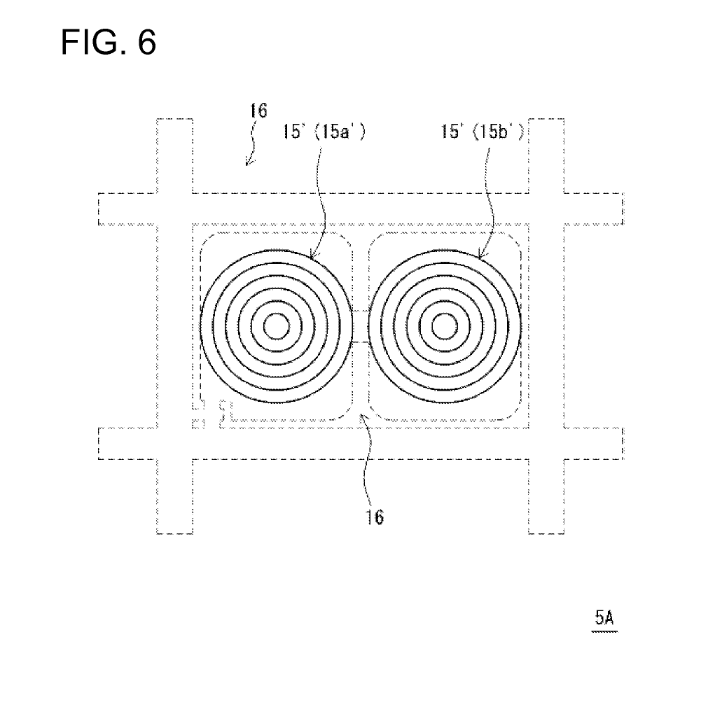

FIG. 6 is an explanatory drawing (plan view) schematically illustrating a portion of a photo-aligning vertical alignment film of a CF substrate according to another embodiment. An alignment film 5A shown in FIG. 6 has orientation control surfaces 15′ (15a′, 15b′) formed by the light radiated concentrically. The respective orientation control surfaces 15a′ and 15b′ are arranged in a manner similar to the alignment film 5 shown in FIG. 3, so as to correspond to and face sub-pixel electrodes 2a and 2b shown in FIG. 2. The respective orientation control surfaces 15a′ and 15b′ are placed so as to fit within the respective electrode planes of the corresponding sub-pixel electrodes 2a and 2b. The alignment film 5A shown in FIG. 6 is provided with the orientation control surfaces 15′ (15a′, 15b′) which have an orientation control force imparted by light radiated concentrically. This type of alignment film 5A also facilitates the radial tilt-orientation of the liquid crystal molecules 14 in a manner similar to the alignment film 5 shown in FIG. 3. In addition, the area 16, which excludes the orientation control surfaces 15′, has a vertical orientation in the same manner as the area 16 in the alignment film 5 shown in FIG. 3.

1. A liquid crystal display device comprising:
a first substrate having a plurality of pixel electrodes thereon;
a second substrate provided with an opposite electrode that faces said pixel electrodes, the second substrate facing said first substrate; and
a liquid crystal layer that is interposed between said first substrate and said second substrate and that contains vertical alignment type liquid crystal molecules,
wherein said liquid crystal molecules are aligned and tilted radially or concentrically with respect to each of the aforementioned pixel electrodes in response to voltage applied between said pixel electrode and said opposite electrode,
wherein either one or both of said first and second substrates have a photo-aligning vertical alignment film which exhibits an orientation control force in response to light illumination, and
wherein said photo-aligning vertical alignment film is disposed to correspond to each of said pixel electrodes and contains a plurality of orientation control surfaces that control the orientation of said liquid crystal molecules radially.

2. The liquid crystal display device according to claim 1, wherein said respective orientation control surfaces of the photo-aligning vertical alignment film exhibits the orientation control force in response to radial or concentric light illumination.

3. The liquid crystal display device according to claim 1, wherein each of said orientation control surfaces of the photo-aligning vertical alignment film is formed by a pinhole exposure.

4. The liquid crystal display device according to claim 1, wherein each of said orientation control surfaces of the photo-aligning vertical alignment film is formed by a microlens exposure.

5. The liquid crystal display device according to claim 1, wherein said pixel electrodes have a rounded shape.

6. The liquid crystal display device according to claim 1, wherein said pixel electrode includes a plurality of sub-pixel electrodes.

7. The liquid crystal display device according to claim 1, wherein said liquid crystal layer including the vertical alignment type liquid crystal molecules contains a chiral agent.
